(19) United States
(12) Patent Application Publication
(10) Pub. No.: US 2003/0069819 A1
(43) Pub. Date: Apr. 10, 2003

(54) System and method for monitering and managing logistics resource information

(76) Inventor: Jack Chen, Los Angeles, CA (US)

Correspondence Address: Maureen Chen, c/o Marlene Reddekopp, 333 Washington Blvd., #24, Los Angeles, CA, 90292, US

(21) Appl. No.: 09/973,305

(22) Filed: Oct. 9, 2001

(51) Int. Cl. G06F 17/60

(52) U.S. Cl. 705/35

(57) ABSTRACT

The method and system of the present invention have the ability to efficiently create dynamic customer accounts in a series of relational databases, process the information associated with the customer accounts, create appropriate financial, shipping and customer account records associated with the customer account, and coordinate all of the information to prepare, track and manage shipments for international transportation of goods in commerce.

### BACKGROUND OF THE INVENTION

A portion of the disclosure of this patent document contains material that is subject to copyright protection.

The copyright owner has no objection to the facsimile reproduction by anyone of the patent document or patent disclosure as it appears in the Patent and Trademark Office, patent file or records, but otherwise reserves all copyright rights whatsoever.

### COPYRIGHT NOTICE

1. Field of the Invention

The present invention relates to methods and an apparatus for third party logistic operations and more specifically to a specialized computer software program and hardware optimized to manage and monitor the multiple pieces of information necessary to provide third party logistic services.

2. Description of the Prior Art

A third party logistics operation encompasses managing and monitoring the many pieces of information and the varied services necessary to conduct international trade. The third party logistics industry comprises numerous independent fields of information; each of which must be managed and monitored for a truly effective operation. For example, monitoring of information is required in the following fields: customs clearance, inland trucking services, vessel chartering services, warehousing, outbound on board information, inbound on board information, container status reports, account financial information, mileage information, inventory information, account information, quotations, arrival notices, release orders, cargo release profile and for many other purposes. Too, the third party logistics industry comprises numerous independent parties responsible for providing the aforementioned list of services; each of which must remain apprised of the status of the many information facets and the status of transaction as a whole.

In the third party logistics industry, there currently exist no computer programs, along with the corresponding infrastructure and methodology, specifically designed to monitor and manage logistic provider services using a graphic user interface that is dynamic in nature. By way of example, a user may enter any of the varied transaction information described above into a computer program designed for multi-field data entry and driven by multiple databases. The multi-field databases are indicative of the above referenced information categories. The user enters a specific piece of data into one particular field, and the database infrastructure dynamically inputs said data input into any field in the program for the particular transaction. To wit: the end user may enter a customer's account information into the ocean outbound segment of the transaction, the customer's account information is dynamically input into all other databases requiring said information, such as the arrival notice and the release order.

In effect, there is horizontal communication between the various components of the system such as customer account, accounts receivable, customer order management, logistics and inventory control to have continual dynamic data flow between these relational databases. As a result, transmission and exchange of information and of documents within the system is minimized thereby making it more efficient, timely and cost efficient. Thereby further reducing the possibility of human error and saving substantial amount of human resources with respect to data input and calculation of corresponding logistics information.

The method of the present invention further comprises the means whereby several end users using a shared network are apprised to a singular set of information that is dynamically managed. Likewise, each party may have access to the various facets of information that may be updated by each end user. Thereby this method allows the various departments of a third party logistics provider; for example, accounting, sales, shipping and the like, to function as an integrated whole without the need for continuous coordination and communication.

There exists a need by third party logistics service providers for a system and method that dynamically inputs and manages the multiple fields of information necessary to facilitate a trade transaction.

There further exists a need in the third party logistics industry for a system and method that inputs the multiple fields of information into a multitude of relational database fields; thereby greatly reducing human error and substantially reducing data input time.

There further exists a need in the third party logistics industry for a system and method that allows all of the parties to the transaction access to the dynamically managed information real-time from geographically remote locations.

There further exists a need in the third party logistics industry for a system and method that integrates all of the departments of a third party logistics provider; for example, accounting, sales, shipping and the like, as an integrated whole without the need for continuous coordination and communication.

In view of the foregoing disadvantages inherent in the known prior art, the present invention provides a new system and method for dynamically inputting and managing and monitoring the various fields of information associated with third party logistic services. In this respect, the method and system of monitoring and managing logistics resource information according to the present invention, substantially departs from the conventional concepts and designs of the prior art, and in so doing provides an apparatus primarily developed for the purpose of providing a method and system of monitoring and managing logistics resource information. Further novel features and other objects of the present invention will become apparent from the following detailed description, discussion and the appended claims, taken in conjunction with the drawings.

### SUMMARY OF THE INVENTION

The general purpose of the present invention, which will be described subsequently in greater detail, is to provide a method and system of monitoring and managing logistics resource information, that is not anticipated, rendered obvious, suggested, or even implied by any of the prior art, either alone or in any combination thereof.

Described briefly, the present invention has the ability to efficiently create dynamic customer accounts in a series of relational databases, process the information associated with the customer account, create appropriate financial and shipping records associated with the customer account, and coordinate all of the information to prepare and manage shipments for transportation from a pre-determined destination to a final pre-determined destination. The method of the present invention inputs information into each sub-system's data base on a real-time basis by horizontal integration of each system to create a harmonious flow of data between databases. This unique concept allows for continual updating of the system over time by inputting information only a single time, and by allowing multiple departments to access and input information into a single customer account.

Moreover, the method and system of the present invention function to simplify the required computational effort in logistics scheduling, distribution and resource allocation. The complexity of coordinating the aforementioned tasks are alleviated by a procedure for problem solving that is unique to method the present invention. The procedure begins by reducing all activities and resources which do not correspond to the input information query, as determined by the end user. Accordingly, all non-feasible information output activities are discarded and all non-feasible resources are discarded, thereby considerably simplifying the solution to retrieving information. For example, an information request may be structured to return only a particular sort field of data, such as the date of a particular transaction; consignee, container number, and the like. Alternatively, corresponding fields of output data may be represented by a particular query, such as multiple fields of quotation information as represented by carrier source, carrier type, and the like.

In operation, an end user wishing to utilize the present invention executes a specially designed graphic user interface (hereinafter referred to as the “GUI”) on the browser of the end user's computer system to interface with the functions and features of the present invention. The interface connects the end user to a Local Access Network (hereinafter referred to as a “LAN”) or a Wide Access Network (hereinafter referred to as a “WAN”) which in turn functions in conjunction with a the host computer server. A plurality of transaction type fields are displayed on the browser of an end user's local computer system. In response to selecting of one of the transaction fields, corresponding account information is executed. The selection causes a display of one or more entry fields for receiving transaction data in response to the field chosen. The transaction data entered and subsequently displayed is stored in a database that corresponds to the selected one of the transaction fields. Each database has a plurality of fields for data that are relational in operation and nature with a plurality of fields and a plurality of databases.

To initiate a transaction request, the end user first must input information into a database in the form of an account set up or a request for information with respect to an existing account. In the case of the former, the end user creates an account; said input is dynamic and is input into all pertinent fields so that information need only be input once. Said dynamic arrangement of information input has many advantages; it greatly reduces the time required for data input and greatly reduces human error associated with thereto. Said transaction account comprises many fields of information, all of which are dynamically managed and updated on a real-time basis. The fields of information may include, but are not limited to: bill of lading details, house bill of lading, notification, consignee notification, shipments, commodity, agent, shipper, carriers, agents and ports, and the like. To begin a transaction account, the customer selects the appropriate transaction field, i.e., customer, shipment, quotation, etc. and inputs the required information using a local computer system. The selection of a particular transaction, also selects a predetermined transaction entry sequence by which transaction data is entered by the user. The transaction entry sequence automatically steps the user through a sequence to access one or more fields using only a pre-selected subset of the full set of fields associated with the account.

In the case of the latter, said host database structures the transaction request using the problem solving method referenced above, and prompts all databases to return the requested information associated with a particular information query. After inputting all of the required transaction information, the end user uploads the transaction information to the host computer server for real-time processing of said information. The host computer server dynamically computes the information request input by the end user, and posts the calculated information on the browser. By way of example, an end user wishing information with respect to a specific shipment may query by information such as consignee, date weight, quantity, destined port location, and the like. All of the information fields necessary to formulate an information query are accessible through a drill down menu located on the task bar of the GUI, thereby making the present invention simple to operate and error free. The GUI further provides the ability to select from among several accounts to provide an easy method for selecting and switching between accounts, and this method is particularly useful in multiple account transaction environments.

In the preferred embodiment of the present invention, all of the departments that comprise the many services associated with third party logistics, are integrated by providing real-time information via the GUI.

The present invention uses a simple visual interface, that is easy to learn, easy to use, and easy to remember how to use, thereby making the entry of transaction data fast and simple, and the retrieval of transaction data fast and simple. Likewise, the user need not compute the many pieces of information required to facilitate an information request. Rather, the user is guided by the GUI and the information is managed and computed by the host computer server thereby saving the customer vat amounts of time and money.

It has been discovered, according to the present invention, that if third party logistic providers can compute a multitude of information from various service providers, real-time, and provide such information on a readily accessible medium, such as the internet, that customers will save substantial amounts of time and money.

It has further been discovered, according to the present invention, that if third party logistic providers can compute a multitude of information from various service providers, real-time, and allow customers to access and update such information on a readily accessible medium, such as the internet, that customers will save substantial amounts of time and money.

It has further been discovered, according to the present invention, that if third party logistic providers can integrate the various parties to a single transaction, via a readily accessible medium, such as the internet, that customers will save substantial amounts of time and money.

It has further been discovered, according to the present invention, that if third party logistic providers can provide the various parties to a single transaction, via a readily accessible medium, such as the internet, a constant and instantaneous channel of communication, that customers will save substantial amounts of time and money.

It is therefore an object of the present invention to provide customers with a compute a multitude of information from various service providers, real-time, and allow said customers to access and update such information on a readily accessible medium, such as the internet, thereby saving said customers substantial amounts of time and money.

It is therefore an object of the present invention to provide customers a multitude of information from various service providers, real-time, and to allow said customers to access and update such information on a readily accessible medium, such as the internet, thereby saving said customers substantial amounts of time and money.

It is therefore an object of the present invention to integrate the various parties to a single transaction, vi a a readily accessible medium, such as the internet, thereby saving said customers substantial amounts of time and money.

It is therefore an object of the present invention to provide the various parties to a single transaction, via a readily accessible medium, such as the internet, a constant and instantaneous channel of communication, thereby saving said customers substantial amounts of time and money.

There has thus been outlined, rather broadly, the more important features of the invention in order that the detailed description thereof may be better understood, and in order that the present contribution to the art may be better appreciated. There are additional features of the invention that will be described hereinafter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

FIGS. 1A-1F is a block diagram of a host system in which the present invention may be advantageously applied.

### DETAILED DESCRIPTION OF THE PREFERRED EMBODIMENT

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents, and alternatives falling within the spirit and scope of the invention as defined by the appended claims.

1. Description of the Preferred Embodiment

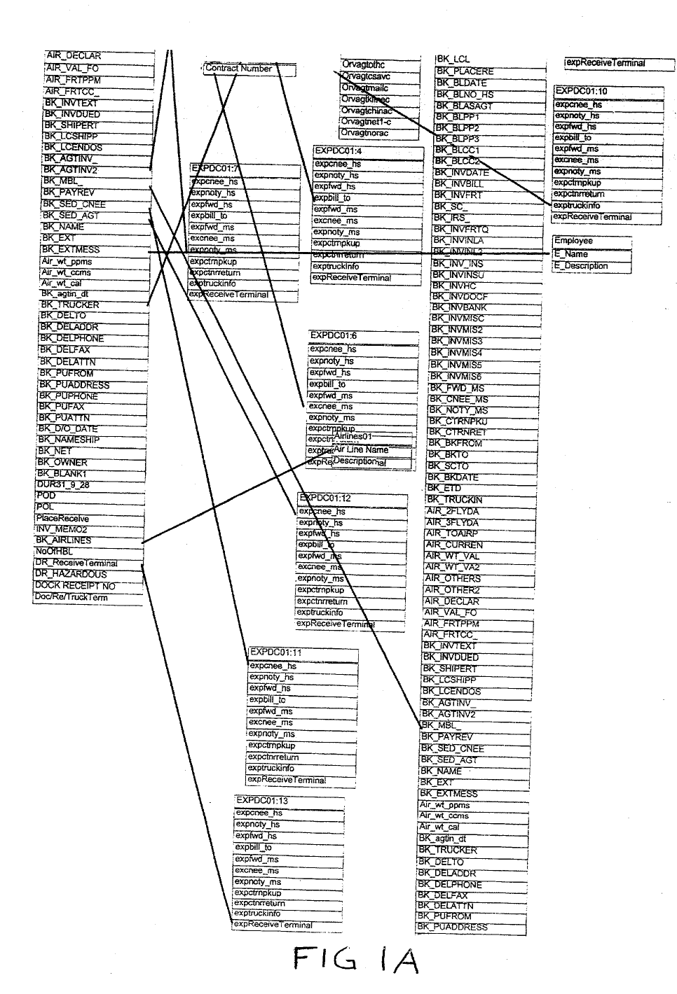

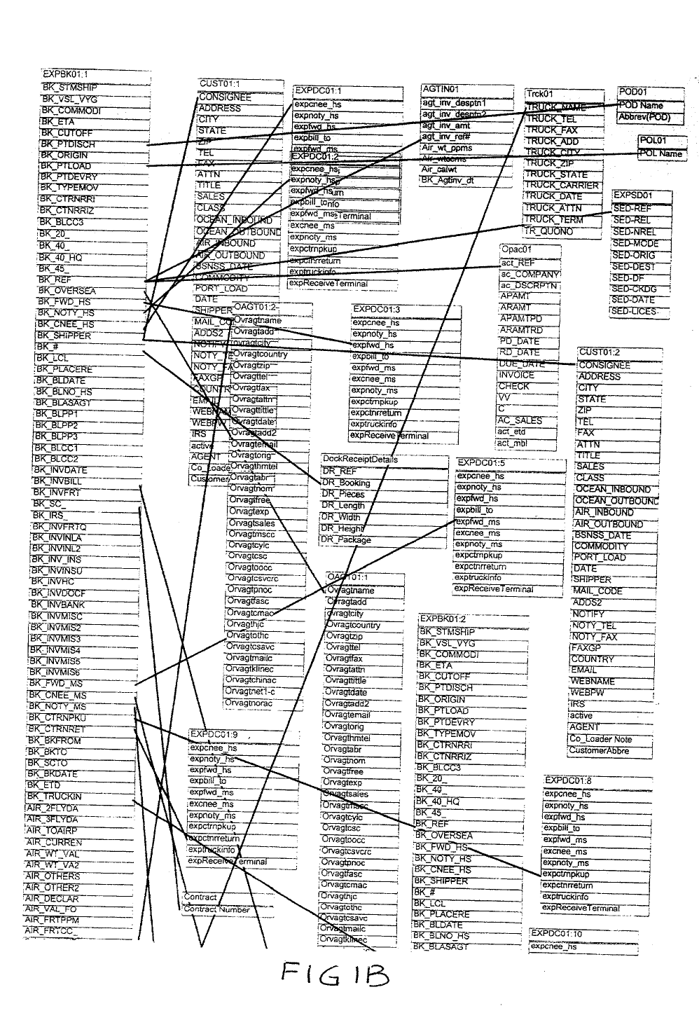

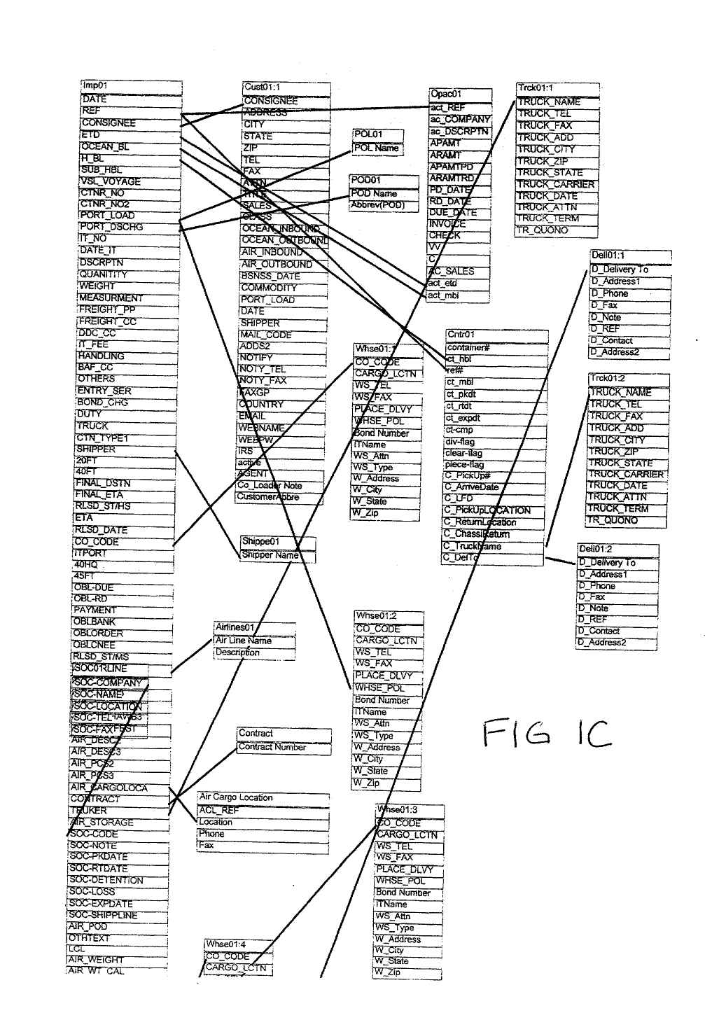

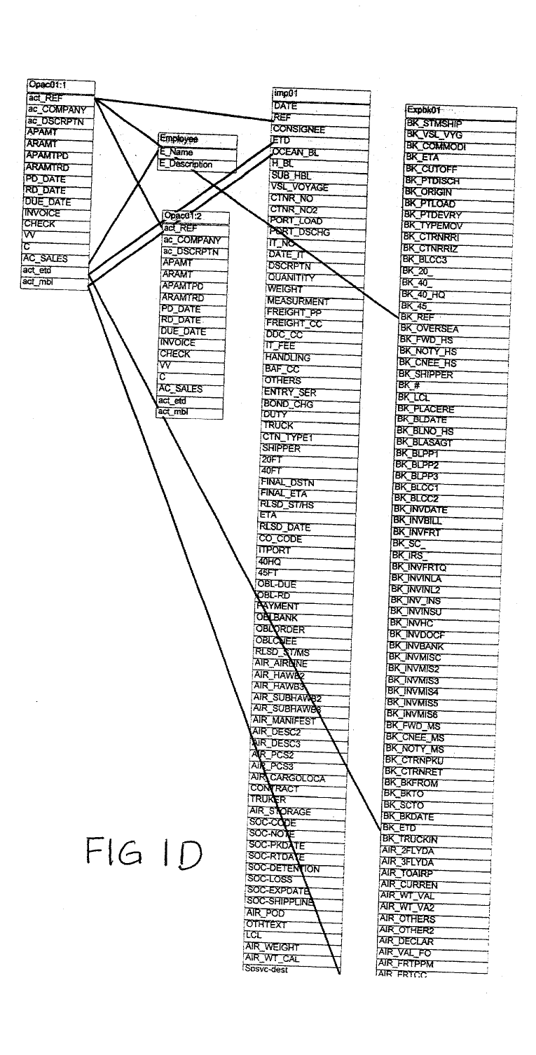

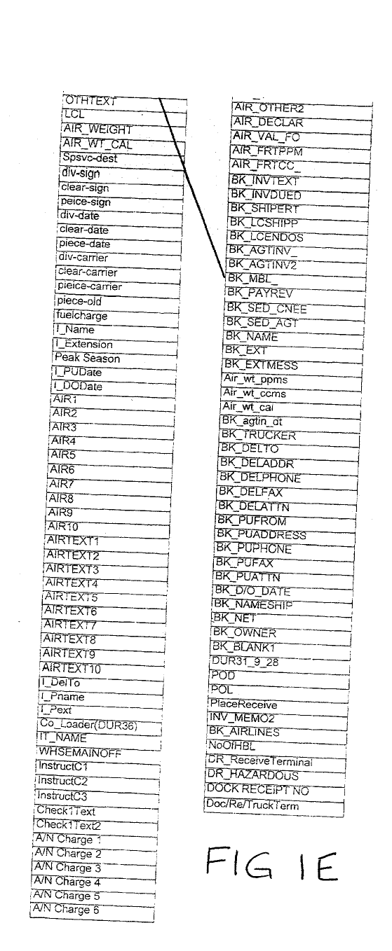

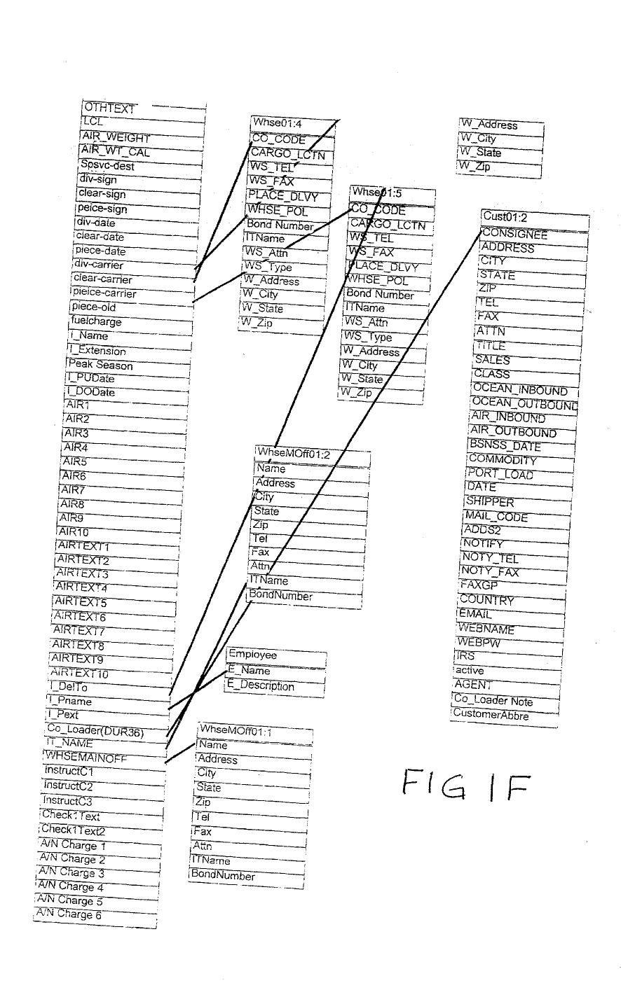

With reference to FIG. 1, the system of the present invention comprises the internet or other TCP/IP based networks, a customer computer system, a graphic user interface, a host computer server, and host computer server databases. The computer of FIG. 1 includes a conventional processor 10, input/output (I/O) devices 11, memory 12 and display 13 of the graphic user interface. The memory 12 stores the operating system 16 for the computer 5, executable computer software 14 which implements the real-time input and real-time tracking method of the present invention and includes the host computer server database 15 where transaction data is stored.

Said host computer databases are configured to dynamically manage the various information associated with a third party logistics provider. Said host computer databases comprise a dynamically driven proprietary arrangement of information that cumulatively serve to efficiently manage and track the various information associated with a third party logistics provider. Said host computer databases include the following fields: bill of lading details, house bill of lading, notification, consignee notification, quotation, shipment, bookings, customers, commodity, consignee commodity, consignee follow up, sales, routing order, shipper, agent, house bill consignee commodity, release order, warehouse, release order details, truck, arrival notice, business categories, companies, company branches, agent carrier, ports and carrier.

Any party to a transaction that requires third party logistic provider services, the “customer”, may initiate a transaction request to the host computer server using a customer computer system. The customer may be, but need not be, the end user, or an authorized party requesting information regarding a particular account. The customer accesses the present invention using a local computer system from a remote location (i.e. the home, office, or a laptop) which establishes internet or TCP/IP connectivity with the host computer server using the database graphic user interface. The graphic user interface runs on the browser of the customer local computer system and provides the interface that allows the customer to operate the present invention by the processes and methods described herein.

With respect to the customer, the graphic user interface is the device that allows the customer to access the present invention, establish a registration account with the host computer server, navigate the database, and to download and upload information from the host computer server. The present invention comprises an application that dynamically manages and tracks the many components associated with an international trade transaction from the point of initiation by the customer to the end point of delivery. Initially, the customer must register with the host computer server which in turn establishes a customer registration account in the database. The customer registration account is the basis upon which the database correlates transaction information and keeps a tracking record of the parties and information peculiar to a particular transaction. The database is a function of the host computer server. The database repository consists of various components of information that are specific to certain transactions and certain sectors or industries related to third party logistic providers. The database further comprises the means to maintain a real-time status function; each of which is unique to a particular transaction request or customer account.

With reference to FIG. 1, a customer with internet or TCP/IP connectivity 10 may either a website, a local access network (LAN) or a wide access network (WAN) using a client-server infrastructure, to provide the point of access to the present invention. In the preferred embodiment of the present invention, the request for third party logistic services is initiated by the customer accessing a website on the world-wide-web using the customer local computer system. The website provides the customer with information about the services available and information in the form of a tutorial on how to register with, and use the present invention. Alternatively, the invention may be configured for use an a restricted LAN or a restricted WAN.

With reference to FIG. 1, registration with the database is a prerequisite to using the present invention by the customer. With respect to the customer, registration enables the host computer server to correlate electronic information requests selected by the customer with that particular customer and with all other authorized parties as identified by the customer during the registration process. Registration further allows the host computer server to associate all electronic information requests with that particular registration account. The tracking mechanism of the host computer server is integral to the function of the present invention for the purpose of managing the transaction cycle, as more fully described below.

2. Operation of the Preferred Embodiment

As the foregoing list indicates, the many pieces of information necessary to operate a third party logistics provider operation are numerous. The present invention serves to dynamically manage and update the various information on a real-time basis, and to allow the end users of the information access to the various information on a real-time basis. FIG. 1 further depicts a representation of the various components of the transaction cycle executed by the system and the components thereof. The transaction display is the software which causes the system to concurrently display a plurality of transaction fields 11, 12, etc. and manage the transaction cycle. Each field has a variety of components particular to that aspect of the transaction. By way of example, for a “quotation” function of the transaction, said field further comprises the fields of quote ID, quote date, consignee ID, agent ID, sales, effective date, expire date, POL, POD, commodity, type of move, place, and note. The corresponding fields operate in the same manner as the foregoing example indicates.

Any number of such transaction fields may be depicted by the graphic user interface. For each field displayed by the graphic user interface, a corresponding customer account exists. The operation of the tracking of each customer account as executed by the host computer server occurs as follows. When the computer system of FIG. 1 is turned on or is otherwise initialized, the tracking code 14 in the memory 12 of FIG. 1 automatically executes image code 23 to display the transaction field images I1, 12, etc. In this mode, the display waits until a end user through the an I/O device selects one of the field images. The selected one of the fields causes entry of data into one of the transaction fields for the purposes of real-time data input and transaction management which corresponds to the selected one of the fields; for example the quotation reference listed above.

Assuming that the field is selected, the transaction entry sequence is then executed. The transaction entry sequence causes one or more transaction display fields (or sequences of fields) to be displayed. Depending on the complexity of the transaction, the display field may include different fields which is a total of fields. Upon display of a transaction display field, corresponding to the transaction entry, data entry is executed, to receive real-time transaction data particular to that portion of the transaction the transaction, such as carrier, port, agent and the like. Upon execution of data entry, the information is stored into the corresponding user transaction accounts. The FIG. 1 embodiment is only one embodiment where certain predetermined fields associated with a customer account are automatically supplied through the entry sequencing. These automatic operations of FIG. 1 greatly simplify the operations required by a customer and provide instant access on a real-time basis to the customer or end user.

The data entry for a transaction is controlled by a transaction entry sequence whereby entry fields are displayed via a screen form, window, dialog or other display field using any I/O device such as a keyboard, touch screen, pen, stylus, mouse, voice, an external device such as a terminal, network link, telephone link, host computer or any other device that inputs data to each field displayed in sequence. The sequence of transaction fields is a function of account type as selected by the customer or end user. For each transaction field, there is a display sequence of the fields with appropriate attributes, and associated prompts, corresponding to the transaction. As an example, a “shipment” field has a subset of fields together which cumulatively provide information with respect to that aspect of the transaction; dependent upon which part of the shipment transaction that the customer or end user requires information about. Said information inquiry is provided by the host computer server real-time to the customer or end user.

The process of performing calculations and logic to display information about transactions in an account and balances and other information about the account. A view may be for any single transaction showing all the information that was originally entered. Optionally, a view may list other information such as the reconciled balance, the total of all transactions that have been marked as reconciled. Optionally, a view may list transactions or totals of transactions for some or all accounts. Optionally, a view may list transactions or totals of transactions grouped by an attribute, such as category.

The first step is to set up the transaction data structure. Then, the transaction display fields of the form are set up which sets up the user interface on the form. The values in the display fields are initialized which sets up each attribute, e.g. Bill Of Lading Details, House Bill Of Lading, Notification, Consignee Notification, Quotation, Shipment, Bookings, Customers, Commodity, Consignee Commodity, Consignee Follow Up, Sales, Routing Order, Shipper, Agent, House Bill Consignee Commodity, Release Order, Warehouse, Release Order Details, Truck, Arrival Notice, Business Categories, Companies, Company Branches, Agent Carrier, Ports And Carrier.

The transaction entry sequence is defined by the layout and selection of transaction display fields on the form. Selection also defines the user interface, as described above. When the user hits the “save” command, the host computer server is called to gather data from the display fields using the pre-determined database functions. Finally, to save the transaction into the account, invokes the storing code. The sequence of display fields is a function of transaction type as selected by the transaction field image. For each transaction image, there is a display sequence of the fields with appropriate attributes, and associated prompts, corresponding to the transaction. As an example, a “quotation” field image or form has a “quote date “field together with an effective date” and “amount” fields. Some field forms share attributes with other forms, and all field forms typically dynamically manage a common subset of information.

The entry sequence presents some or all of the attributes a transaction may have, as appropriate for the selected transaction. For each attribute, them is a set of user interface elements, that constitute a display field, that respond to input to receive the associated attribute's value. Typically, the entry sequence defines the data entry fields, then retrieves the values at the end of the sequence from the host computer server.

The process of performing calculations and logic is displayed as information about transactions in an account and other information about the account. A view on a customer's graphic user interface may be for any single transaction showing all the information that was originally entered, or as modified by the customer. Optionally, a view may list transactions or totals of transactions for some or all accounts. Optionally, a view may list transactions or totals of transactions grouped by an attribute, such as category. Examples of viewing operations that are performable with the computer and software include the following: query database for a list of accounts; for each account, compute transaction data requested by the customer, such as warehouse and bond number; and display the account information in the appropriate format.

The host computer server sets up the transaction data structure, along with the transaction display fields of the form which in turn are set up on the user interface on the form. The values in the display fields are initialized which sets up each attribute, e.g. bill of lading details, house bill of lading, notification, consignee notification, quotation, shipment, bookings, customers, commodity, consignee commodity, consignee follow up, sales, routing order, shipper, agent, house bill consignee commodity, release order, warehouse, release order details, truck, arrival notice, business categories, companies, company branches, agent carrier, ports and carrier. The transaction entry sequence is defined by the layout and selection of transaction display fields on the form. When the user hits the save command, the database is called to gather data from the information fields using the pre-determined host computer server functions.

The graphic user interface further comprises a visual representation (image) that is recognizable as a symbol for identifying a transaction, an account, an attribute of an account or other information relating to an account. The visual representations are displayed as fields, icons, buttons, or other similar likenesses. Selecting a transaction image activates a transaction entry sequence.

For each account or any other attribute, the present invention can display the transactions it comprises in a list on-screen or in printed form.

The terms used in connection with transaction tracking are defined as follows:

Account

A totality of transactions (together with accumulated totals and other information). Examples of accounts are bill of lading details, house bill of lading, notification, consignee notification, quotation, shipment, bookings, customers, commodity, consignee commodity, consignee follow up, sales, routing order, shipper, agent, house bill consignee commodity, release order, warehouse, release order details, truck, arrival notice, business categories, companies, company branches, agent carrier, ports and carrier.

Transaction

An operation that identifies a transfer in connection with an account. A transaction typically has the following attributes, customer, date, account, and transaction type. The database comprises the means for storing multiple transactions for an account, albeit each transaction is typically for only one account. Each account has a balance or total, which is the sum of the amounts of the transactions in that account. Once recorded in the account store, each transaction can be subsequently edited or deleted by the customer or the host computer server.

Transaction Entry Sequence

The data entry for a transaction is controlled by a transaction entry sequence whereby entry fields are displayed via a screen form, window, dialog or other display field using any I/O device such as a keyboard, touch-screen, pen, stylus, mouse, voice, an external device such as a network link, telephone link, host computer or any other device that inputs data to each field displayed in sequence. The sequence of display fields is a function of account type as selected by the transaction field. For each transaction image, there is a display sequence of the fields with appropriate attributes, and associated prompts, corresponding to the transaction. As an example, a “quotation” form further comprises an “effective date” field together with an expiration date” and “amount” fields. Some forms share attributes with other forms, but typically as a minimum all forms have the following information, in whole or in part, bill of lading details, house bill of lading, notification, consignee notification, quotation, shipment, bookings, customers, commodity, consignee commodity, consignee follow up, sales, routing order, shipper, agent, house bill consignee commodity, release order, warehouse, release order details, truck, arrival notice, business categories, companies, company branches, agent carrier, ports and carrier.

Host Computer Server Calculation

The process of performing calculations and logic to display information about transactions in an account and other information about the account. A calculation may be for any single transaction showing all the information that was originally entered about the account or any one piece of information about the account. Optionally, a calculation may list some information, or the total of all transaction information that have been selected by the customer. Optionally, a view may list transactions or totals of transactions grouped by an attribute, such as category. Examples of viewing operations that are performable with the computer and software include the following: Viewing account information with respect to bill of lading details, house bill of lading, notification, consignee notification, quotation, shipment, bookings, customers, commodity, consignee commodity, consignee follow up, sales, routing order, shipper, agent, house bill consignee commodity, release order, warehouse, release order details, truck, arrival notice, business categories, companies, company branches, agent carrier, ports and carrier.

There has thus been outlined, the more important features of the invention in order that the present contribution to the art may be better appreciated. It is to be understood that the invention is not limited in its application to the details of construction and to the arrangements of the components set forth in the foregoing description or illustrated in the drawings. The invention is capable of other embodiments and of being practiced and carried out in various ways. Also, it is to be understood that the phraseology and terminology employed herein are for the purpose of the description and should not be regarded as limiting.

What is claimed:

1. In a clustered computing network having a plurality of computers connected to a plurality of storage devices through a plurality of adapters, a system for shipping of I/O requests including: a communication medium interconnecting said plurality of adapters for peer to peer communication there between; a directory stored in a memory within at least one of said plurality of adapters for storing location information regarding blocks of data stored within said plurality of storage devices; and managing means operable within said at least one adapter of said plurality of adapters an associated with said communication medium and with said directory for selecting which of said plurality of adapters should process a received I/O request from one of said plurality of computers and for shipping said received I/O request via said communication medium to another of said plurality of adapters in response to the selection, wherein said managing means is operable within said at least one adapter independent of said plurality of computers and is operable to ship a received I/O request to said another of said plurality of adapters transparently with respect to said plurality of computers.

2. The system of claim 1 wherein said managing means includes: updating means within said at least one adapter for revising said directory with information regarding the location of blocks of data within at least one of said plurality of storage devices.

3. The system of claim 2 wherein said updating means is operable for updating said directory in response to receiving location information from said plurality of adapters regarding blocks of data.

4. The system of claim 1 wherein said directory includes: a local portion corresponding to data stored in a portion of said plurality of storage devices connected to said one of said plurality of adapters; and a remote portion corresponding to a portion of said plurality of storage devices connected to others of said plurality of adapters.

5. The system of claim 4 wherein said managing means includes: searching means to search said local portion and said remote portion of said directory to select which of said plurality of adapters should process the received I/O request; first determining means for deciding whether said at least one adapter can process the received I/O request in response to said searching means locating the requested blocks in said local portion; and second determining means for deciding whether another of said plurality of adapters can process the received I/O request in response to said searching means locating the requested blocks in said remote portion and in response to said first determining means.

6. The system of claim 1 wherein said storage devices include disk arrays.

7. The system of claim 6 wherein said storage devices further include RAID management means to store data and redundancy information.

8. The system of claim 1 wherein at least one computer of said plurality of computers creates said directory and distributes said directory to said plurality of adapters.

9. The system of claim 8 wherein said system further comprises: updating means in said at least one computer to update said directory and to distribute the updated directory to said plurality of adapters.

10. The system of claim 1 wherein said at least one of said plurality of adapters creates said directory and distributes said directory to others of said plurality of adapters.

11. The system of claim 10 wherein said managing means further comprises: updating means to update said directory and to distribute the updated directory to others of said plurality of adapters.

12. A method for shipping of data block I/O requests among a plurality of adapters which connect a plurality of storage devices to a plurality of computers in a clustered computer network, said method comprising the steps of: determining, within said plurality of adapters, which of said plurality of adapters should process a received I/O request from one of said plurality of computers; and communicating among said plurality of adapters via said communication medium to ship said received I/O request from one of said plurality of adapters to another of said plurality of adapters for processing, wherein the method is operable within said plurality of adapters independent of said plurality of computers and is operable to ship a received I/O request to said another of said plurality of adapters transparently with respect to said plurality of computers.

13. The method of claim 12 wherein the step of determining includes the step of: searching a directory, within said plurality of adapters, that includes location information regarding blocks of data within said plurality of storage devices.

14. The method of claim 13 wherein said directory includes a local portion corresponding to data stored in a portion of said plurality of storage devices connected to said one of said plurality of adapters and a remote portion corresponding to a portion of said plurality of storage devices connected to others of said plurality of adapters, and wherein the step of searching includes the steps of: searching said local portion to determine whether said one of said plurality of adapters can process said I/O request; and searching said remote portion to determine whether another of said plurality of adapters can process said I/O request in response to the determination that said one of said plurality of adapters cannot process said I/O request.

15. The method of claim 12 further including the step of: creating a directory which maps the location of blocks of data within at least one of said plurality of storage devices.

16. The method of claim 15 wherein the step of creating a directory further includes the step of: distributing said directory to said plurality of adapters.

17. The method of claim 16 wherein the step of creating a directory further includes the steps of: coalescing information regarding the location of blocks of data within said plurality of storage devices; and building said directory using said coalesced information.

18. A system for I/O shipping of an I/O request comprising: a plurality of host adapters for connecting at least one host computer that generates said I/O request to at least one I/O device; a communication medium interconnecting said plurality of host adapters, wherein said plurality of host adapters connect said at least one host computer to said communication medium; and shipping means within said plurality of host adapters and coupled with said communication medium, for shipping said I/O request to an identified one of said plurality of host adapters via said communication medium, wherein said shipping means is operable within said plurality of adapters independent of said at least one host computer and is operable to ship a received I/O request to said identified one of said plurality of adapters transparently with respect to said at least one host computer.

19. The system of claim 18 wherein said shipping means includes: a directory mapping the location of data in I/O devices of said at least one I/O device associated with said plurality of host adapters; and search means, coupled with said directory, for searching said directory to locate data requested by said I/O request to thereby identify said identified one of said plurality of host adapters capable of processing said I/O request.

20. The system of claim 19 wherein said directory includes: a local portion corresponding to data stored in a portion of said at least one I/O device connected to a corresponding one of said plurality of host adapters; and a remote portion corresponding to a portion of said plurality of said at least one I/O device connected to others of said plurality of host adapters.

21. The system of claim 20 wherein said search means includes: searching means, within at least one adapter of said plurality of host adapters, for searching said local portion and said remote portion of said directory to select which of said plurality of host adapters should process said I/O request; first determining means for deciding whether said at least one adapter can process the I/O request in response to said searching means locating the requested blocks in said local portion; and second determining means for deciding whether another of said plurality of host adapters can process the I/O request in response to said searching means locating the requested blocks in said remote portion and in response to said first determining means.

22. A clustered computer network, comprising: a first node, including: a first host computer with a first processor bus; a first bus bridge connected to said first processor bus; a first host bus adapter; a first peripheral bus connected to said first bus bridge and said first host bus adapter, wherein said first bus bridge and said first peripheral bus provide communication between said first host computer and said first host bus adapter; and a first storage device that is accessed by said first host bus adapter; a second node, remote to said first node, including: a second host computer with a second processor bus; a second bus bridge connected to said second processor bus; a second host bus adapter; a second peripheral bus connected to said second bus bridge and said second host bus adapter, wherein said second bus bridge bus and said second peripheral bus provide communication between said second host computer and said second host bus adapter; and a second storage device that is accessed by said second host bus adapter; and an adapter communication medium that provides communication between said first and second host bus adapters, wherein said first host bus adapter routes I/O requests from said first host computer for said first storage device to said first storage device and ships I/O requests from said first host computer for said second storage device across said adapter communication medium to said second host bus adapter independent of said first host computer, thereby relieving said first host computer of determining which of said storage devices said I/O requests from said first host computer are directed to, and said second host bus adapter routes I/O requests from said second host computer for said second storage device to said second storage device and ships I/O requests from said second host computer for said first storage device across said adapter communication medium to said first host bus adapter independent of said second host computer, thereby relieving said second host computer of determining which of said storage devices said I/O requests from said second host computer are directed to wherein the shipping of I/O requests is transparent with respect to said first host computer and said second host computer.

23. The network of claim 22 further including a computer communication medium that provides communication between said first and second host computers, wherein said computer communication medium does not provide communication between said first and second host bus adapters, and said adapter communication medium does not provide communication between said first and second host computers.

24. The network of claim 22 wherein said first storage device includes a first array of disk drives, and said second storage device includes a second array of disk drives.

25. The network of claim 22 wherein said first and second host bus adapters communicate with one another in accordance with an I.sub.2 O protocol.

26. The network of claim 22 wherein said first host bus adapter responds to said I/O requests from said second host adapter by enabling said second host adapter to logically share said first storage device, and said second host bus adapter responds to said I/O requests from said first host bus adapter by allowing said first host bus adapter to logically share said second storage device.

27. The network of claim 22 wherein said first host bus adapter permanently physically owns said first storage device for I/O requests in said network for said first storage device and permanently logically shares said second storage device for I/O requests from said first host computer for said second storage device; and said second host bus adapter permanently physically owns said second storage device for I/O requests in said network for said second storage device and permanently logically shares said first storage device for I/O requests from said second host computer for said first storage device.

28. The network of claim 22 wherein said first host computer includes first processors, said first processor bus provides communication between said first processors, and said first peripheral bus provides communication between said first processors and said first host bus adapter without providing communication between said first processors; and said second host computer includes second processors, said second processor bus provides communication between said second processors, and said second peripheral bus provides communication between said second processors and said second host bus adapter without providing communication between said second processors.

29. The network of claim 22 wherein said first host bus adapter consists essentially of a first peripheral bus interface for interfacing with said first peripheral bus, a first internal bus connected to said first peripheral bus interface, a first internal bus bridge connected to said first internal bus, a first internal processor bus connected to said first internal bus bridge, a first central processing unit and a first memory connected to said first internal processor bus, a first storage device interface connected said first internal bus for interfacing with said first storage device, and a first adapter communication medium interface connected to said first internal bus for interfacing with said adapter communication medium; and said second host bus adapter consists essentially of a second peripheral bus interface for interfacing with said second peripheral bus, a second internal bus connected to said second peripheral bus interface, a second internal bus bridge connected to said second internal bus, a second internal processor bus connected to said second internal bus bridge, a second central processing unit and a second memory connected to said second internal processor bus, a second storage device interface connected said second internal bus for interfacing with said second storage device, and a second adapter communication medium interface connected to said second internal bus for interfacing with said adapter communication medium.

30. The network of claim 22 wherein said first host bus adapter includes a first routing host bus adapter for routing I/O requests for said first data storage device to said first data storage device, and includes a first shipping host bus adapter for shipping I/O requests from said first host computer for said second storage device to said second host bus adapter via said adapter communication medium and for transferring 1/O requests from said second host bus adapter via said adapter communication medium to said first routing host bus adapter for transfer to said first storage device; and said second host bus adapter includes a second routing host bus adapter for routing I/O requests for said second data storage device to said second data storage device, and includes a second shipping host bus adapter for shipping 1/O requests from said second host computer for said first storage device to said first host bus adapter via said adapter communication medium and for transferring I/O requests from said first host bus adapter via said adapter communication medium to said second routing host bus adapter for transfer to said second storage device.

31. The network of claim 30 wherein said first routing host bus adapter consists essentially of a first routing peripheral bus interface for interfacing with said first peripheral bus, a first routing bus connected to said first routing peripheral bus interface, a first routing bus bridge connected to said first routing bus, a first routing processor bus connected to said first routing bus bridge, a first routing central processing unit and a first routing memory connected to said first routing processor bus, and a first routing storage device interface connected to said first routing bus for interfacing with said first storage device; said first shipping host bus adapter consists essentially of a first shipping peripheral bus interface for interfacing with said first peripheral bus, a first shipping bus connected to said first shipping peripheral bus interface, a first shipping bus bridge connected to said first shipping bus, a first shipping processor bus connected to said first shipping bus bridge, a first shipping central processing unit and a first shipping memory connected to said first shipping processor bus, and a first shipping adapter communication medium interface connected to said first shipping bus for interfacing with said adapter communication medium; said second routing host bus adapter consists essentially of a second routing peripheral bus interface for interfacing with said second peripheral bus, a second routing bus connected to said second routing peripheral bus interface, a second routing bus bridge connected to said second shipping bus, a second routing processor bus connected to said second routing bus bridge, a second routing central processing unit and a second routing memory connected to said second routing processor bus, and a second routing storage device interface connected to said second routing bus for interfacing with said second storage device; and said second shipping host bus adapter consists essentially of a second shipping peripheral bus interface for interfacing with said second peripheral bus, a second shipping bus connected to said second shipping peripheral bus interface, a second shipping bus bridge connected to said second shipping bus, a second shipping processor bus connected to said second shipping bus bridge, a second shipping central processing unit and a second shipping memory connected to said second shipping processor bus, and a second shipping adapter communication medium interface connected to said second shipping bus for interfacing with said adapter communication medium.
